(19) United States
(12) Patent Application Publication
(10) Pub. No.: US 2005/0096048 A1
(43) Pub. Date: May 5, 2005

(54) Optimized network employing seamless and single sign on capabilities for users accessing data applications on different networks

(75) Inventors: Varsha Clare, Pleasanton, CA (US); Allen Billings, San Francisco, CA (US); Kent Hughes, Oakland, CA (US)

Correspondence Address: McDERMOTT, WILL & EMERY, 600 13th Street, N.W., Washington, DC, 20005-3096, US

(73) Assignee: Cellco Partnership

(21) Appl. No.: 10/695,805

(22) Filed: Oct. 30, 2003

(51) Int. Cl. H04Q 7/20

(52) U.S. Cl. 455/433; 455/432.1

(57) ABSTRACT

The concepts herein address a communication network for managing user identifiers of users accessing data applications on at least two different networks each accessible through a service provider, and providing a seamless sign on when accessing a data application from a mobile station. A wireless communication network links a mobile station with a data application on the wireless network, and a user accessing the data application from the mobile station is identified by a user identifier entered by the user. A communication network other than a wireless communication network links a user interface other than a mobile station with a data application on the other communication network, and the user accessing the data application from the user interface is identified by the user identifier entered by the user. A computer system is in communication with data applications of the wireless communication network and with the other communication network. The computer system facilitates user sign-on capabilities to the data applications from the mobile station and the user interface with the same user identifier. If accessing the data application from the wireless communication network, a computer system leverages authentication information from the Home Location Register for authenticating and authorizing access to the data application for seamless sign-on.

### TECHNICAL FIELD

The concepts disclosed herein relate to optimal database utilization in a wireless communication network and in other communication networks different from wireless, for employing relatively uniform user access for all services offered at platforms used by the wireless communication network and/or the other communication network.

### BACKGROUND

In the past decade, personal digital communications and devices have advanced and overtaken the predecessor analog communication and devices. Not only is voice transmitted in a more efficient and cleaner manner, transmission of data to/from cellular phones is possible. Coinciding with the evolution of the internet, specific data-based applications for cellular telephones and the like have become increasingly possible and readily available. These applications include, but are not limited to, e-mail, web access, text-messaging, Push-To-Talk, 802.11, etc., and offer access in a variety of ways. First, a user may access multiple application(s) from a mobile station or from a computer via the internet. Second, each physical type of access may allow the user to access multiple mobile service related applications, e.g. e-mail and web browsing from the mobile terminal, and e-mail and account or service management from an internet connected computer. In any event, the user is required to recall multiple variations of a username/password depending on the terminal from which the user obtains access and/or the specific application accessed.

The complexity of user access has been due to the separate growths of wireless technology and the internet. A user accessing a web-based application links to the application typically over the internet, whereas a user accessing a wireless-based application links to the application over a wireless network. Authentication and authorization are carried out differently on each network. Thus, username/password management differs. If the applications reside on different network servers, the servers may impose different security restrictions.

What is needed is a network infrastructure optimized to permit a single username/password for all applications accessible by a service provider regardless of the types of network hosting the various applications offered by the service provider. The logon process should be seamless to the user.

### SUMMARY OF THE INVENTION

The concepts disclosed herein alleviate the above noted problems by optimizing different networks and/or applications to implement seemless and single-sign on environment.

More particularly, for single sign-on, a communication network offers management of user identifiers of users accessing data applications via at least two different networks. The network includes wireless communication network providing a link to a mobile station and access to a data application associated with the wireless network. A user accessing the data application from the mobile station is identified by mobile station identifiers. The network also includes another communication network other that links a user interface other than the mobile station with a second data application. The user accessing the second data application from the user interface is identified by the user identifier entered by the user. A computer system in communication with data applications of the wireless communication network and with the other communication network facilitates user sign-on capabilities to the data applications from the user interface with the same user identifier.

The computer system is configured to verify the identity of the user accessing the second data application and is configured to store the user identifier for other data applications of a plurality of data applications. The computer system is also configured for receiving any one of a new, changed, and updated user identifier from the data application associated with the other communication network or the data application associated with the wireless communication network, and for populating the received user identifier with the data applications in the communication network.

Also, the computer system is in communication with a third-party network hosting a third-party data application. A Lightweight Directory Access Protocol (LDAP) interface interfaces the third-party network with the computer system. An authorization server may connected between the interface and the computer system, or the computer system may be configured to authenticate and authorize access to the third party data application and a data application of either the wireless or the other communication network.

For seamless sign-on, a computer system in communication with the data applications of the wireless communication network facilitates user sign-on capabilities to the data applications from the mobile station by leveraging authentication already performed by the Home Location Register (HLR) corresponding to the mobile station identifiers. The computer system is configured to query the HLR for an authenticated mobile station accessing the wireless communication network. Then, the computer system verifies the identity of the user accessing the data application based on the authenticated mobile station leveraged from the HLR corresponding to the mobile station identifiers received from the data application. In this way, a username/password may not be needed for accessing the data application from the wireless network.

With this communication system, a method and program product for managing authentication of a user accessing data applications of a service provider via at least two different networks for single sign on and seamless sign-on is provided.

Additional objects, advantages, and novel features of the embodiments will be set forth in part in the description which follows, and in part will become apparent to those skilled in the art upon examination of the following and the accompanying drawings or may be learned by practice of the invention.

### DESCRIPTION OF THE FIGURES

The drawing figures depict preferred embodiments by way of example, not by way of limitations. In the figures, like reference numerals refer to the same or similar elements.

FIG. 1 is a block diagram of a wireless communication network.

FIG. 2A is a block diagram of a web-based communication network.

FIG. 2B is a block diagram of a product server incorporating a database for data storage.

FIG. 2C is a block diagram of a product server in communication with an external database for data storage.

FIG. 3A is a block diagram of an optimized communication network having the AAA server configured as a computer system.

FIG. 3B is a block diagram of an optimized communication network having a computer system in communication with the AAA server.

FIG. 3C is a block diagram of an optimized communication network having a computer system represented by a combination of the AAA server and another server in communication therewith.

FIG. 4 is a block diagram of another communication network configuration sharing components of the wireless communication network and web-based communication network.

### DETAILED DESCRIPTION

The inventors have developed a system which optimizes and synchronizes access or authorization databases on both a wireless communication network and a network different from a wireless-based communication network, such as a web-based network. On a wireless network, a database maintains secure parameters assigned to a user's mobile station. However, on a web-based network, a separate database maintains usernames and passwords assigned to, or chosen by, each user. Following the system disclosed herein, a user is permitted to access data applications from a mobile station by leveraging parameters authenticated by the HLR. Also, separate databases on different networks may be interfaced with one another, and even further, the different networks may share a common database or databases. By optimizing the two networks in the foregoing manner, a user need not remember a username and password for each application the user accesses. Depending on the network from which the user accesses data applications, the user may be authenticated by mobile station identifiers or a username/password entered by the user. Also, the user enjoys the benefit of being able to use the same username and password for all applications with the optimized network and database configuration.

First, there will be a discussion and illustration of a wireless communication network and enhancements, and next, a discussion of a web-based network, followed by a discussion of optimal and efficient database utilization between the two.

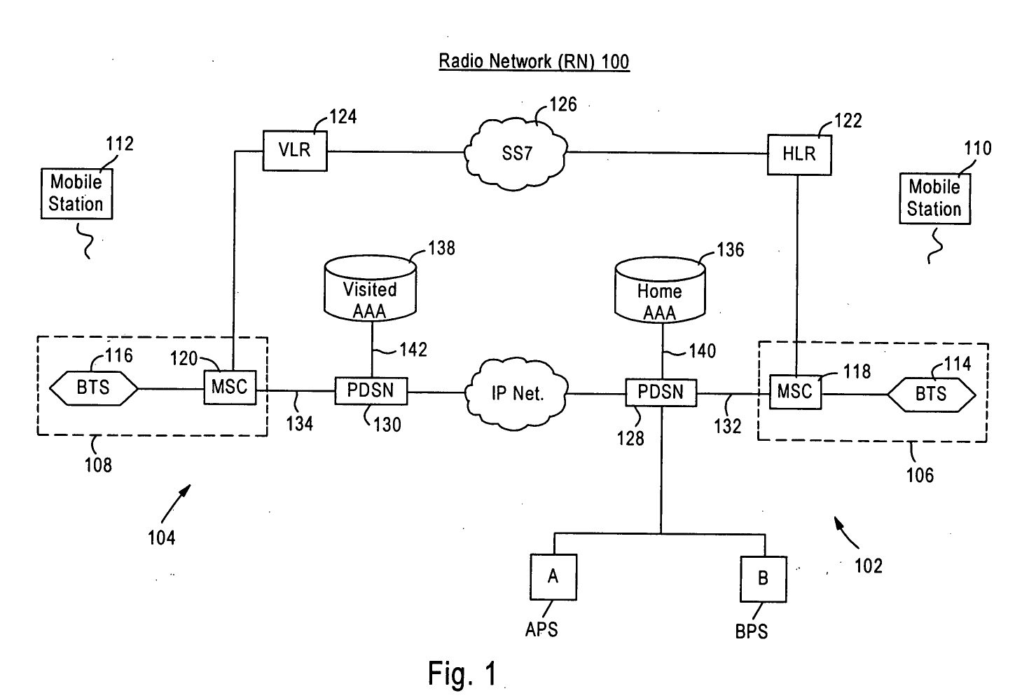

Referring to FIG. 1, there is shown an example of a wireless communication network (RN) 100, although it should not be taken as definitive, as other network types and configuration are possible. RN 100 comprises access networks operated by a large number of separate and independent service providers. For discussion purposes, FIG. 1 illustrates two such networks 102 and 104. These networks 102 and 104 offer communication services to customers using mobile stations throughout a wide geographic area. Customers subscribe to service using mobile stations and through various providers. Therefore, any one network may accommodate its own subscribers as well as visitors. Although the illustrated radio network RN (100) provides services and access for many customers, only two such stations 110 and 112 are illustrated. For discussion purposes, these two stations 110 and 112 are assumed to be in use by subscribers to network 102 and not 104. Thus, as illustrated, the subscriber via mobile station 110 is located within the home service area of network 106. Conversely, subscriber via mobile station 112 has roamed into a different geographic area and is receiving wireless service from visitor service area 106 of another network 108. Hereinafter, network 104 will be referred to as a “visited” network 104, and network 102 will be referred to as “home” network 102.

Mobile stations 110 and 114 may take many forms, which include but are not limited to, mobile telephone stations, portable digital assistants (PDA's) with wireless communication abilities, wireless devices connected to laptop computers, and any other types of devices configured to communicate over the radio network 100.

The mobile station 110 and 114 constitutes the interface between the mobile subscriber and the base station. Besides voice communications, mobile stations 110, 112 provide control and signaling functions. Mobile stations 110, 112 are able to tune, under system command, to a logical channel in the frequency spectrum allocated to the system. Each logical channel comprises a pair of channels for two-way conversation. Power level of the transmitter can also be controlled by the system.

Physical elements of the home and visited networks 102, 104 include base transceiver systems (BTS) 114 and 116 respectively, otherwise known as a base station 114 and 116, which make up the parts of the network that send and receive radio signals to and from the mobile stations 110, 112 it currently serves. The BTS 114 and 116 each include antenna systems, towers, transmitters, and receivers (not shown) at the site. The BTS is responsible for the control, monitoring, and supervision of calls made to and from each mobile station within its serving area. Each BTS 114, 116 assigns and reassigns channels to the mobile stations 110, 112 and monitors the signal levels to recommend hand-offs to other BTSs (not shown).

The base station controller (BSC) 118 and 120 is a centralized processor that controls functions of a number of respective BTSs 114 and 116, and manages how calls are made and are transferred (or handed-off) from one BTS to another. Each wireless network equipment vender implements this function differently. Some vendors have a physical entity, which they call a BSC, while other vendors include this functionality as part of their mobile switching centers (MCS) 118, 120. For convenience, the BSC 114 and 116 is illustrated associated with the MSC 118, 120, respectively.

As mentioned above, mobile stations 110 and 112 are provisioned between a home network 102, and other stations (not shown) are provisioned on network 104, respectively, each serving a geographic area. Within the home service area, for example the area of network 102, a Home Location Register (HLR) 122 stores for data application subscriber packet data subscription service options and capabilities. Thus, the HLR 122 uses this service information to provide, manage, limit, etc. subscribed services to each user's mobile station 110, including certain data services.

In the event that a customer roams outside of the home service area, as in the case of mobile station 112, service information is downloaded from the HLR 122 to the Visitor Location Register (VLR) 124 in the visited network 104. For a successful registration process, the visited network 104 assigns a register (not shown) in VLR 124 to mobile station 112 during the period when a customer roams within the visitor service area. In order for the VLR 128 to authenticate mobile station 112, the VLR 124 communicates with the HLR 122, typically via packet massages exchanged via a SS7 interoffice signaling network 126.

In order to obtain access to the RN 100, each service provider assigns its subscribers Mobile Identification Numbers (MIN) (identity of the mobile station within the wireless communication network) and Mobile Directory Numbers (MDN) (i.e., phone numbers), which are stored in the HLR 122 and associated databases. Also, each mobile station 110, 112 has a dedicated Electronic Serial Number (ESN). When within a service area, mobile stations 110, 112 continually monitor control channels, which provide a path in which to initiate and receive calls. In this regard, mobile stations 110, 112 can remain in constant contact with respective base stations BSTs 114, 116. The identifiers discussed above will be commonly referred to as “mobile stations identifiers,” and may include other identifiers well within the level of ordinary skill in the art.

During at least an initial registration attempt for a mobile station, the mobile station sends its MIN and ESN pair to a respective BTS. In order to authenticate respective mobile stations 110, 112 within a network, the HLR 122 confirms that the MIN and ESN pair received from a mobile station match the same stored in its database. Once the ILR 122 has authenticated mobile station 110 (confirmed a match), the user is free to use the mobile station for voice needs. Other security measures to ensure the user is the actual user are well known in the art and are not explicitly discussed herein.

The network 100 also includes a Packet Data Service Node (PDSN) 128, 130, which is a fixed network element introduced in the architecture for third-generation (3g) networks, to support packet data services. The respective interface between mobile switching centers 118, 120 and PDSNs 128, 130 are often referred to the R-P interface 132, 134. The PDSN 128, 130 establishes, maintains, and terminates logical links to the associated radio network, and in this case, network 106 and 108. The PDSNs 128, 130 also support PPP sessions with the mobile stations 110, 112.

One function of PDSNs 128, 130 is to communicate between Authentication, Authorization and Accounting servers (AAA) 136, 138 and the MSC 118 and 120. The PDSN 128, 130 performs many functions, some of which include the following: (1) collecting usage data for accounting purposes, which is relayed to the AAA server 136, 138; (2) routing packets to/from external packet data networks, i.e., the internet, specific applications, etc.; and (3) any other types of communication required between the AAA server 136, 138 and any other types of applications.

While one AAA server 136, 138 is illustrated for each network 102, 104, specific radio networks commonly include more than one AAA server 136, 138. AAA servers 136, 138 leverage authentication that occurs in the HLR 122 or VLR 124 for both simple IP and mobile IP, discussed further below. These servers 136, 138 perform a variety of functions, including an accounting record, maintaining an interim accounting record, and stopping an accounting record for a packet data communication service. Though not provided in all networks, all authentication, authorization and accounting transactions may be performed using the RADIUS (Remote Authentication Dial-In User Service) protocol. RADIUS protocol has been in use for years and is used in the ISP (Internet Service Provider) networks. RADIUS 140, 142 is typically the interface between the PDSN 128, 130 and the AAA server 136, 138. In this capacity, RADIUS 140, 142 serves the client-server role, where the PDSN 128, 130 acts as the client and the AAA 136, 138 acts as the server.

RN 100 also includes data applications A, B maintained by product servers APS and BPS, respectively. A product server may include any type of server or network for hosting a data application. Data applications A and B represent applications providing data services, specialized voice services, applications communicating over IP, etc., each accessible via mobile stations 110, 112. Although the data services may be available from third parties, for discussion purposes the data application service A and B are assumed to be offered by one service provider, e.g. the wireless carrier or an associated party. Typical examples of data applications A and B include Push-To-Talk services, application download services using cellular networks based on the IEEE 802.11 standard, and any other type of application designed for primary access over a wireless network. For ease of discussion, description of applications A and B will be limited to the home network 102. However, the visitor network 104 may accommodate applications as well.

As mentioned above, the HLR authenticates mobile stations for voice needs. Typically, the AAA authenticates the mobile station for accessing data application with the user name/password combination. Authentication in each instance increases processing time and the time required by the user to obtain access to any particular data application. Thus, it is desirable to implement a system for “seamless sign-on” by user. By effectively combining the authentication by the HLR with authentication by the AAA server, traditional sign-on requirements to any particular data application on the wireless network is not required. In other words, by leveraging the authentication performed by the HLR the AAA server need not separately authenticate a mobile station when a user attempts to access any particular data application. In other words, because the HLR previously authenticated a mobile station, the same mobile station does not need to be re-authenticated when a user attempts to access a data application.

Leveraging authentication of the HLR server may be carried out periodically or when a request to any particular data application is received at the AAA server. Typically, the AAA server will send a request to the HLR station, and request authenticated mobile stations currently accessing the wireless network. This data may be stored in the AAA server for future processing of access request to data applications on the network. Alternatively, the AAA server may request whether or not a particular mobile station attempting to access a data application has been authenticated by the HLR station. In either event, the AAA server leverages the HLR authentication so as to authorize or prohibit access to a data application by a user accessing via a mobile station. Thus, instead of providing a username/password combination to the data application, the network takes advantage of mobile station identifiers which have been processed by the corresponding HLR in order to determine whether or not a mobile station and user is permitted to access a particular data application.

More particularly, when the user requests a data session with data application A or B, a session is set up through the HLR 122, and by communicating with the AAA server to authenticate for verifying identity and to authorize for determining a level of access. First, the PDSN 128 assigns an IP address to the mobile station 110 requesting service. Assignment of an IP address may be done in accordance with Simple IP (SIP) or Mobile IP (MIP). SIP is a service in which the user is assigned a dynamic IP address from the serving PDSN 128. MIP is a service in which the subscriber is assigned an IP address that does not change as the customer changes its point of contact with the network 100. In contrast with one another, MIP allows a subscriber to roam beyond the area served by the PDSN 128 that assigned the IP address, whereas using SIP, there is no mobility beyond the area served by the PDSN 128 that assigned the IP address, and thus, no hand-offs between PDSN 128. Regardless of the method for assigning an IP address, the AAA server stores assigned IP addresses of each user and corresponding “mobile station identifiers,” such as MINs, MDNs, ESNs, and a user identifier, such as a username and password.

Next, the user requesting service must be authenticated, otherwise known as “authentication.” In order to protect against fraudulent access to data applications A and B on respective product servers APS and BPS, the product servers will perform an authentication of the user in order to verify the identification of the user requesting service. Basically, the AAA server compares mobile station identifiers from a product server with authentication information leveraged from the HLR and preferably stored in the AAA server. If data matches, the user is granted access to the network.

More particularly, in order to gain access, mobile station IDs are sent to the AAA together with the user's IP address. The AAA server compares received mobile station identifier with those entered by the user requesting service. In the event of a match, the user has been authenticated. In the event that the identifiers do not match, the product server may immediately terminate the session, provide an information screen instructing the user to contact customer service, etc. Other techniques of authenticating a user are well known and are not explicitly discussed herein.

Once a user has been authenticated by the product server (i.e., the AAA server verified the user's identity), the user may need to be authorized to use a corresponding data service. Though many levels of authorization may be used, there are two basic types. First, basic authorization verifies that the user is authorized to use the service. Second, service type authorization determines the service type (i.e., class of service) to which the user has subscribed. Preferably, the AAA server performs both types of authorization, or separate AAA servers may perform each type, or selective AAA servers may perform authorization depending on the application the user attempts to access.

Authentication and Authorization may be carried out simultaneously or at different times. If the AAA server that leverager authentication information from the HLR also performs authorization, the AAA server may perform Authentication and Authorization for the user generally at the same time. In other words, when the AAA server authenticates a user with received mobile station identifiers, authorization information may be performed at the same time.

For basic authorization, the product server sends to the AAA server the user's mobile station identifiers. Since the AAA server stores the identity of applications to which each user has access, upon receipt of mobile station identifiers, the AAA server may determine if a user is permitted to access the requested service. In turn, the AAA server sends a yes/no value to the product server. A “yes” signifies that the user has authorization to use the service, and a “no” signifies that the user is not authorized. In the event that a “no” is returned, a telephone number, web address, etc., may be presented to the user in order to gain access.

Some applications may have various levels of service. For example, a user's subscription may be limited to certain features hosted by the application. If the application employs predefined service types, when the AAA server performs basic authorization mentioned above, the AAA server will check and return a service class or type, which may be preset by the application and product server.

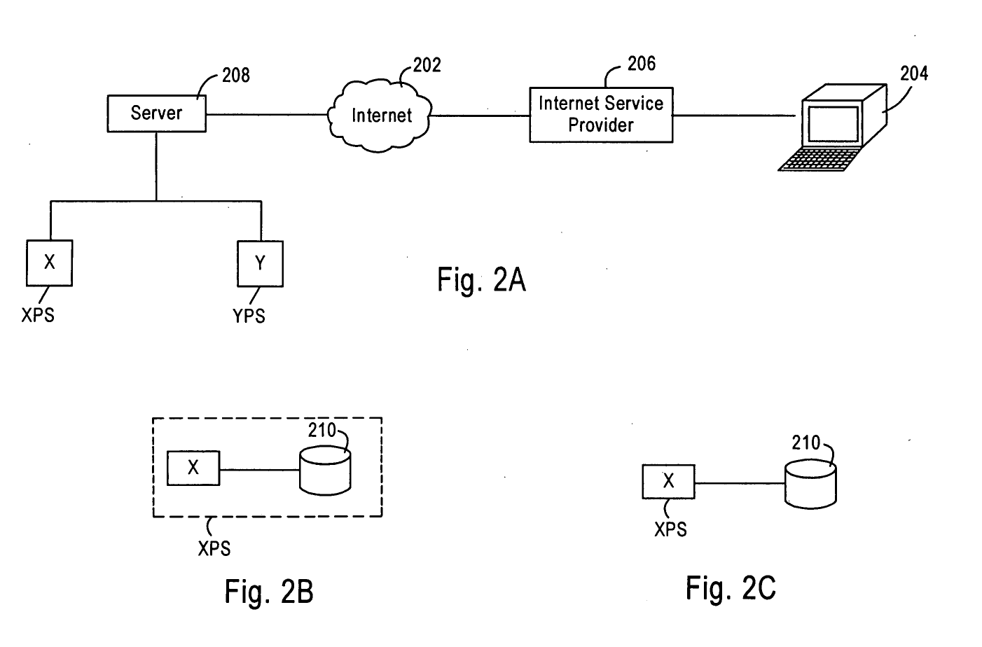

FIG. 2A illustrates in block diagram a web-based network for accessing the internet. A user connects to the internet 202 via a user interface 204, such as a computer, using an Internet Service Provider (ISP) 206. For connecting to a specific application, the user typically contacts a remote server 208 having an assigned Internet Protocol (IP) address, and the remote server 208 links the user to other product servers and/or databases maintaining a particular application that the user chooses to access. In the alternative, the remote server may maintain the particular application, which the user accesses.

FIG. 2 illustrates two data applications (X and Y), which embody any type of data application accessible over the internet. For discussion purposes, applications X and Y represent data applications accessible via the internet for sending data to the station user, e.g., on their personal computer 204, or to their mobile station 110 as set up by the user. On the internet, many such applications are deployed by many different parties and are accessible from both mobile and landline user terminals. For purposes of this discussion, it is assumed that applications X and Y are deployed by the same service provider or an associated party provides applications X and Y. Typical examples of data applications X and Y include text messaging services, and any other type of application which is customizable by accessing the application over the internet 208. Applications A and B, which relate to mobile services, may be accessible via this user interface 204 as well. The user may manage his/her profile, update account information, purchase upgrades, etc.

Also data applications X and Y may be accessible by user subscription only, and hence require authentication of the user who attempts to obtain access. However, in some instances, data applications X and Y may be accessible to the public at large, and therefore may not require authentication in the conventional sense. Even further, a user may access data applications X and Y on a trial basis. As a result, authentication and authorization play an important role in at least protecting against fraudulent access and limiting access.

Authentication and Authorization, in some respects, are similar to the Authentication and Authorization carried out on a wireless network. However, since a user is not using a mobile station having mobile station identifiers, security is somewhat degraded. To cope with this, a username and password assigned to the user, or that the user chooses, serves to authenticate users accessing data applications X and Y.

Although authentication may be characterized in the context of supplying a username and password, other forms of user identifiers known to those of ordinary skill in the art may be employed such as pins, secure identification tags (e.g., token keys), etc. These identifiers may be used when accessing data applications from the wireless network. The level of authentication required may depend on the application the user attempts to access. Hereafter, various forms of user identification on both a wireless communication network and other networks will be generally referred to as “user identifiers.”

Referring to FIGS. 2B-D, each product server XPS, YPS, hosting data applications X, Y respectively, communicate with a database 210 for storing user identifiers, user profile information, and any other types of information associated with the user. This database 210 may be located on the same product server of the respective data application X and Y, as shown in FIG. 2B, or may be located on a different product server, i.e., external to the product servers for respective applications, as shown in FIG. 2C.

When prompted for user identifiers, the user enters his/her user identifier in designated query fields, and the user's terminal device transmits the data to the particular network. The data application product servers XPS, YPS compares the entered user identifier with a stored user identifier after first querying the product server database 210 (FIG. 2B), or a database 210 (FIG. 2C) external to the product server. If the entered user identifier matches the stored user identifier, the user will be permitted to access the selected application.

If a user attempts to link to a different application after previously entering a user identifier, the remote server 208 may encrypt the user identifier and send the encrypted user identifier to the other product server hosting the other data applications. The other product server may decrypt the user identifier, and verify that the user is the correct user. This has several benefits for the user and the system. First, the user does not have to continually re-enter his user identifier for each application selected. Also, efficiency is improved, as the remote server 208 does not have to query users for each attempted access. However, if the user identifier is incorrect, i.e., data applications X and Y have stored different user identifiers, access will be denied.

Authorization may be performed for each user attempting to access an application. Authorization can be thought of as the level of service to which the user has subscribed. As levels of service may differ for each user, preferably the database 210 tracks the level of service permitted for each user. This database 210 may be the same as the database storing user identifiers, discussed above, or may be a wholly separate database 210 located on the product server, on a different product server, or external to the product servers.

For authorization, the product servers XPS, YPS query the database storing authorization levels, and checks the level of service to which the user has subscribed. Implementation of authorization may be performed in various ways. The product server may query each time the user attempts to access part of the application assigned to a different level of service, or the product server may return a permission set limiting access within the application.

In summary, wireless service providers provide at least two types of services to its customers, (1) voice and data applications accessible over the wireless network and (2) access to one's account and other data applications over the internet. By leveraging authentication performed by the HLR, the AAA server need not perform a true authentication process for each data application. Thus, a user may enjoy the benefit of seamless sign-on.

Concurrent with the expansion of the types of applications A, B, X, Y, network consolidation and optimization are of concern to the inventors of this application. The inventors found that it is desirable to marry network infrastructure for wireless data applications A and B and web-based applications X and Y while maintaining the “single sign-on” environment. To do so minimizes network facilities, which in turn minimizes fraudulent ways to obtain service while enhancing user friendliness. Also, y consolidating network infrastructure, single sign-on will be enhanced.

From the user's perspective, single sign-on requirements will be the same regardless of the interface from which the user attempts to access any one of data applications A, B, X, and Y. For example, the user need only remember a user identifier for accessing each data application regardless of whether the data application is primarily accessible from a wireless communication network or a web-based communication network. To accomplish a single sign-on environment, network infrastructure must be enhanced so as to share user identifiers among all data applications A, B, X, and Y on different types of networks, and to populate new, change, or updated user identifiers with each of the data applications A, B, X, or Y or populate them in a central location. Upon entry, the respective data application to which the user attempts to gain access from a land-line terminal will verify, or authenticate, the username and password combination entered by the user with the user identifiers stored locally, or in a central database. If a user attempts to access a data application A, B, X, Y from a mobile station, similarly, the user will be authenticated with authentication information leveraged from the HLR. Upon entry, the data application A, B, X, Y verifies or authenticates user identifiers received from a product server with corresponding mobile station identifiers. By automatically updating user identifiers for all data applications accessible from a service provider with the AAA server or some other database common to both wireless and web-based networks popularity and a central authentication point for data applications A, B, X, Y is created. As a result, a more friendly single sign-on environment may be accomplished.

Also, the inventors have found that functionality is increased if users are able to access data applications A, B, X, and Y from multiple platforms, e.g., a mobile station, a computer, a PDA, etc. Web access to applications A, B, primarily accessible only by a mobile station, may permit a user to manage his/her user profile, optimize buddy lists, sign-up, etc. Similarly, mobile station access to applications X, Y, primarily accessible only over the web, may permit the user to manage the same attributes. As a result, functionality is increased, creating a user-friendly environment. However, without modifying existing infrastructure, user friendliness could nonetheless be degraded. Thus, it is desirable to centralize user identifiers for the set of applications accessible from the mobile station, computer, or both through the service provider to provide a single sign-on environment together with a seamless sign-on environment.

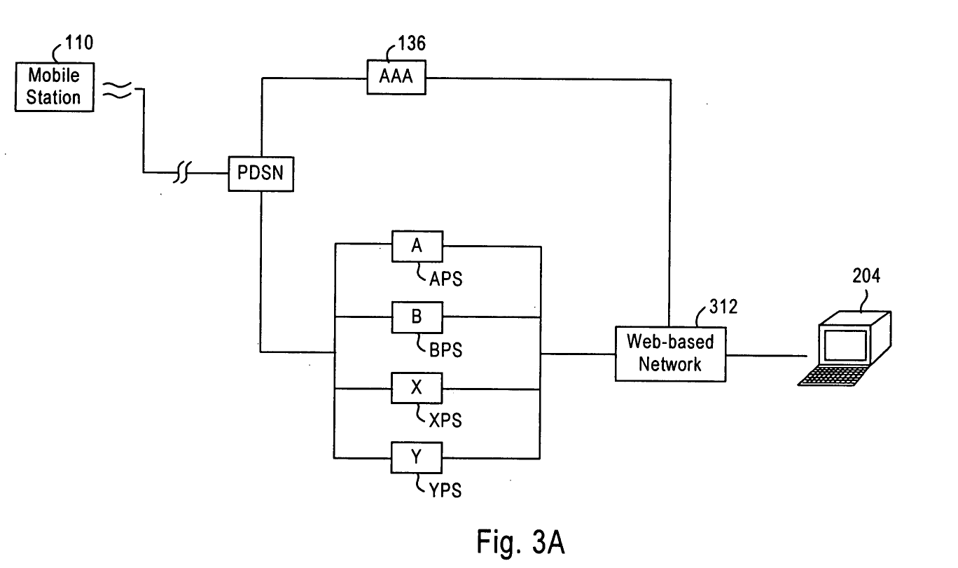

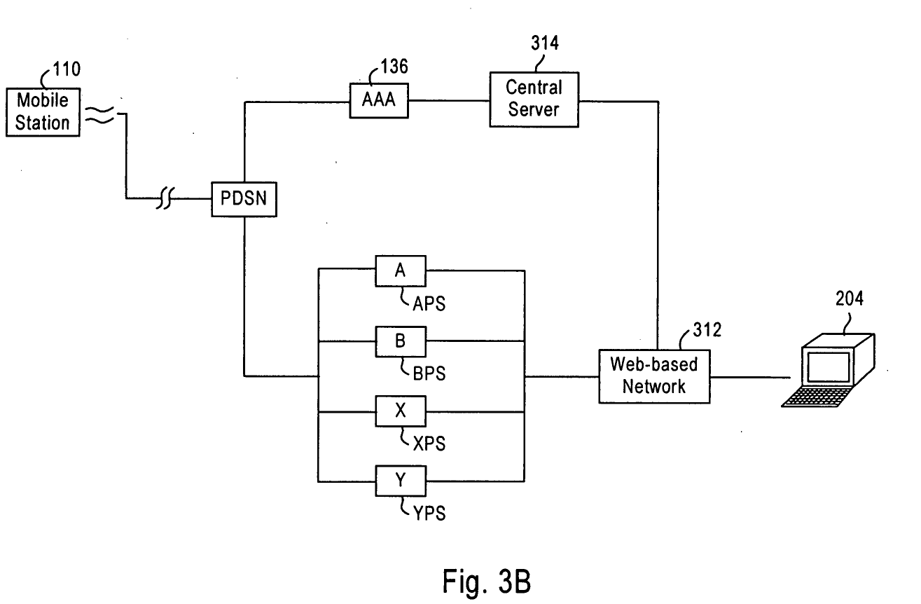

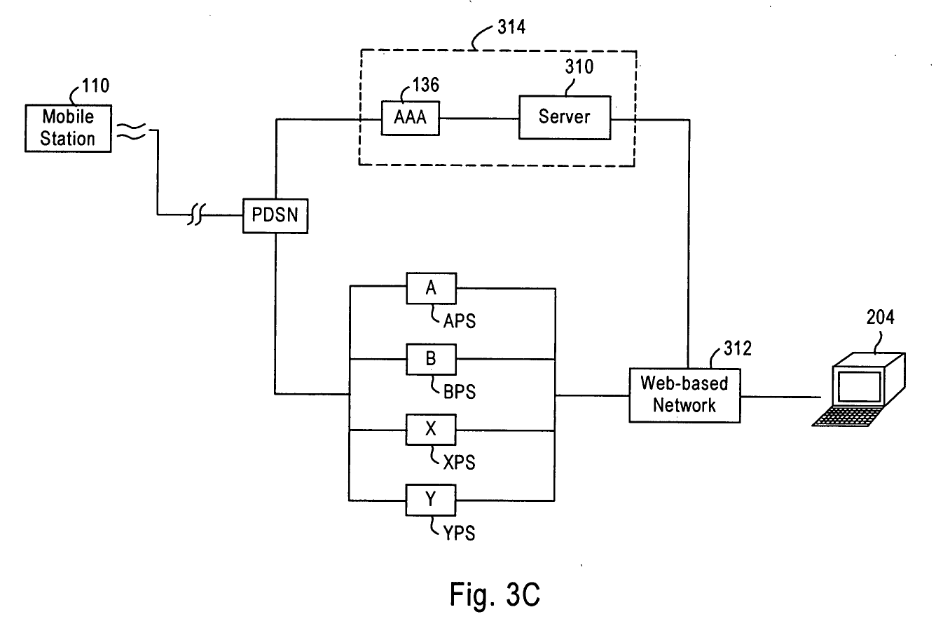

One way to centralize user identifiers is to store the information on the AAA server 136, a server 310 in direct communication therewith, or a combination of the two, illustrated by FIGS. 3A-3C, respectively. More specifically, FIG. 3A illustrates the AAA server 136 capable of centrally storing user identifiers; FIG. 3B illustrates a server 310 other than the AAA server 136 for centrally storing user identifiers; and FIG. 3C illustrates a combination of the AAA server 136 and another server 310 for centrally storing user identifiers.

In each configuration, the server or group of servers maintaining user identifiers is generally referred to as a “computer system” 314. If using a combination of servers as FIG. 3C illustrates, preferably, the AAA server 316 authenticates and authorization mobile stations over the radio network 100, and the other server 310 authenticates and authorizes other devices accessing applications over a web-based network 312. The AAA server 136 periodically connects to database 310 and downloads, new, updated or changed user identifiers, after which time user identifiers are removed from the database 310. In this manner, a service provider can easily update a system to accommodate single sign-on capabilities. From the user standpoint, there is no change.

By populating user identifiers and corresponding mobile station identifiers on the computer system 314, applications A, B, X and Y need only query or access a central location to check user identifiers. In other words, to support web access, the computer system 314 must manage user identifiers for all applications A, B, X, Y, and be in communication with those applications A, B, X, Y, regardless of the network on which data applications A, B, X, Y reside.

Basically, the computer system 314 may be used to populate user identifiers for each data application A, B, X or Y in order to serve as a central management point. In this configuration, the computer system 314 may function as a data store while existing product servers APS, BPS, XPS, and YPS perform front end authentication of a user. In the alternative, the computer system 314 may serve as both a data store and also as the front-end management for user authentication. The two options will be discussed in turn.

If a computer system 314 is a data store, product servers APS-YPS preferably use existing infrastructure in order to perform user authentication, which have been discussed above. With this implementation, in the event that the user changes user identifier for any one of data applications A, B, X, Y, user identifiers would be updated by the respective product server APS, BPS, XPS, YPS in corresponding local databases 210. In order to implement a single sign-on environment, any change in user identifiers is populated to other servers and in respective databases 210.

In order to update user identifiers, the respective product server APS, BPS, XPS, YPS initiating the change sends a message to the computer system 314 informing the computer system 314 that a user identifier has changed. Since the computer system 314 already has information on each of the data applications A, B, X and Y, the computer system 314 may send a message to the other product servers hosting data applications A, B, X, Y to which the user subscribes informing that user identifiers has been updated and provide corresponding user identifiers. In the alternative, the computer system 314 may populate user identifiers in all databases regardless of whether or not the user subscribes to every data application A, B, X, Y. In this embodiment, the computer system 314 functions solely as a data store in order to ensure that user identifiers are the same in each storing entity, i.e., in each database 210.

The foregoing implementation has several advantages. First, in order to implement a single and seamless sign-on environment, the existing infrastructure does not have to be dramatically changed. Only the computer system 314 must be updated in order to provide user identifier management capabilities as well as interface functionality with the HLR. The existing product servers APS, BPS, XPS, YPS continue to function in the conventional manner except that regular updates of user identifiers will be sent by the computer system 314, and user identifiers are populated accordingly. Second, by storing user identifiers locally on a product server APS, BPS, XPS, YPS, access to each data application A, B, X, Y will not be degraded. Third, when the user or server provider updates or changes user identifiers, the change need only be made on one data application or on the computer system 314. The computer system 314 will populate the change throughout the system. As a result, a user is not burdened with the need to remember multiple variations of user identifiers and need only update user identifiers in one application, which would be applied to the entire system.

If the computer system 314 is configured for front-end management and data store, data applications A, B, X and Y do not populate user identifiers locally on each database 210 corresponding to product server APS, BPS, XPS, YPS. Instead, all user identifiers may be populated only on the computer system 314. In this embodiment when a user enters a user identifier to access a respective data application A, B, X, Y, the respective product server will query the computer system 314 sending user-entered information. The computer system will return status of the comparison and whether the user has been authenticated. In this embodiment, respective product servers APS, BPS, XPS, YPS do not have to maintain user identifiers locally on databases 210, nor do they have to continually update user identifiers as with the first option.

Implementation of the single sign-on environment is not limited to the two options discussed above, as a combination of the two options may be employed. For example, in the event a service provider adds applications and product servers (not shown), which do not include integrated user identifier management databases 210, the new product server may rely on the computer system 314 as the front-end management and data store while the existing product servers APS, BPS, XPS, YPS rely on the computer system as simply a data store. Various implementations are possible and they are well within the level of one of ordinary skill in the art. By populating user identifiers centrally between two different networks, data applications A, B, X, Y can easily be expanded to allow entry of user identifier from a mobile station and from a user interface via different networks. Advantageously, a user need only remember a username and password for all data applications, and changes thereto are automatically populated within all data applications.

In summary, the conventional AAA server 136 is devoted to wireless applications only. In accordance with the novel features discussed herein, the AAA server 136 may be modified for leveraging authentication by the HLR and to accommodate user identifiers for a wireless communication network and a network other than a wireless communication network such a web-based network 312. In order to modify the AAA server 136, an interface may be built between a web-based server 310 and the AAA server 136, which updates user identifier in the AAA server 136. The AAA server may function in concert with another server to perform authentication and authorization or a server separate from the AAA server may perform authentication and authorization for all applications. In any event, if the customer changes or updates user identifier from the web-based user interface 204, or from a mobile station 110, the new changed, updated information may be populated in a central location. A service provider may choose to modify existing infrastructure with an interface incorporating a user identifier management system or connect directly to the AAA server 136 depending on cost-efficiency, ease of implementation, etc.

Regardless of the configuration of network infrastructure to implement a single sign-on environment, from the user's perspective from a land-line terminal, sign-on requirements will be the same. From a mobile station, however, sign-on will be seamless, thus, not requiring a username/password. For example, a user accessing a data application A, B, X, Y from a mobile station on a wireless network will not be prompted for user identifiers. Because user identifiers are stored locally on the respective data application server, when accessing from a land-line, the data application or product server need only compare received user identifiers with stored user identifiers in order to authenticate and eventually authorize the user for a level of service. If user identifiers are stored on a computer system, such as a AAA server, authentication and authorization will be performed from the AAA server. Regardless of the network infrastructure, from the user's perspective, sign-on requirements will seem the same from a land-line terminal and enhanced from a mobile station. Thus, access from either a mobile station on the wireless network or a user interface on a network other than the wireless network, the same user identifier would be required for accessing data applications A, B, X, Y or the mobile station identifiers would be used. In this way, the user enjoys the benefit of not being required to remember multiple user identifiers, and can access all data applications A, B, X, Y accessible from a service provider using the same user identifier, and enjoy enhanced sign-on capabilities.

If a third party network separate from the user's service provider hosts third party applications, authentication and authorization may be carried out in a different manner. Further network optimization merges sign-on capabilities to permit third-party partners to query the home service provider for selected information to authenticate the user and authorize the use of the third-party application and populate user identifiers to ensure seamless and single-sign on capabilities extend to third-party applications. In other words, the same user identifier and mobile station identifiers for each data application A, B, X, Y including those hosted by a third party, may be populated in the central location accessible by a third party.

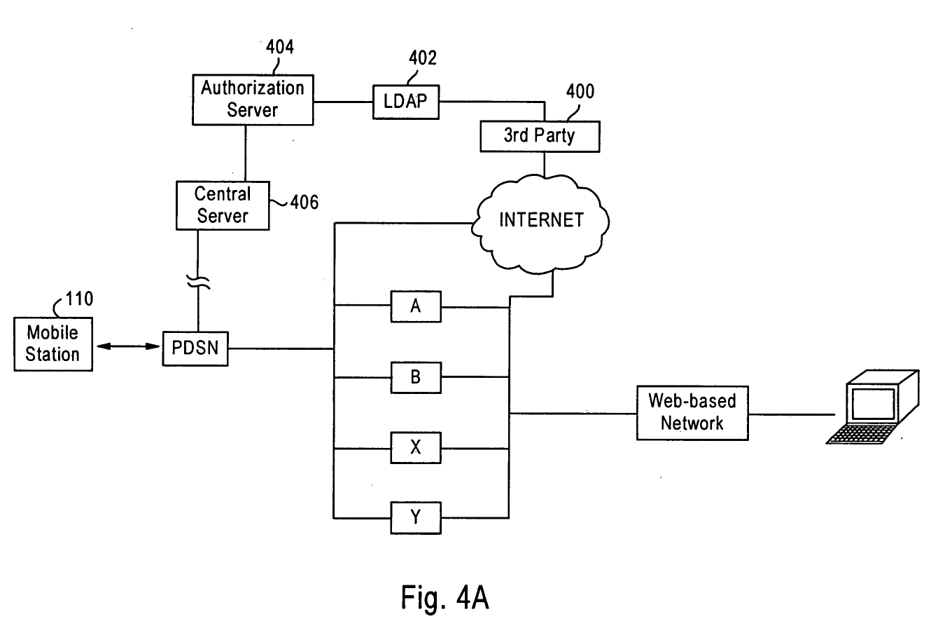

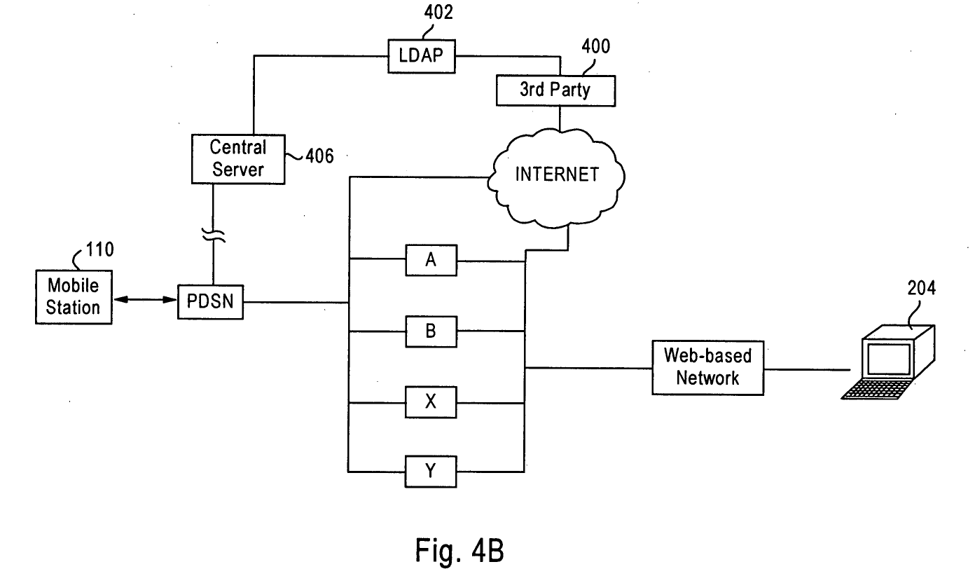

One way to implement the foregoing is to include an authorization server on the service provider's network. The authorization sever may interface with the third party applications only or interface with both the third party applications and data applications on the service provider's network via computer system 406, as in FIG. 4A. In the alternative, the authorization server may be eliminated and the computer system 406 interfaces with the third-party partner, as in FIG. 4B.

A third party 400 may host any type of third-party data application accessible from mobile station 110 or user interface 204. Examples of third party applications may include Microsoft Bundles, i.e., a data application that is not hosted by a user's service provider, but is accessible from either a web-based network or a wireless communication network. Typically, a user connecting to third party applications access the applications through the internet. In order to implement a seamless and single sign-on environment for all data applications accessible through a service provider, including those offered by a third party, an interface must be established between the third party 400 and a database hosted and managed by the service provider. FIG. 4A illustrates the third party application 400 linked to an authorization server, and FIG. 4B illustrates the third party linked with a computer system via a Lightweight Directory Access Protocol (LDAP) interface. Though other interfaces are available for linking a third party to the respective service provider, an LDAP interface provides a simpler connection to the third party network and service providers networks.

Authorization definitions for third party partners may have a different format than the definitions used on the service provider's network. Thus, the authorization server 404 or computer system 406 must support the ability to create and modify service definitions or fields associated with different applications. Also, the authorization server 404 or computer system 406 should provide a secure method to identify a third party to determine whether the third party is allowed to receive requested information.

The authorization server or computer system should also allow for different service provider internal users to read, add, modify and remove service definitions through a convenient user-interface. This interface must have multiple levels of security and user rules. Preferably third party partners should only be able to read data stored on the server while the service provider should have capabilities to add, delete, update and read the data.

A Lightweight Directory Access Protocol (LDAP) interface interfaces with third-party partners requesting access to the authorization computer system. Queries from third parties will include the identity of the third-party requester, identify of the subscriber by user identifiers, and the names of the requested service authorization fields or parameters based on the requested type. The authorization server will send a query response to the product server, and the requested service authorization fields or parameters, based on the requested type. Additionally, the authorization server shall support queries from specified product servers that will return the values of all service authorization fields or parameters.

Also, the authorization server shall support a method to securely authenticate specified service provider or third party product service. The authorization server will store configuration information for each individual product server, which will include, at a minimum, a list of authorization fields or parameters that each product server is allowed to query. Each individual product server must only be allowed to query for authorization fields or parameters specified in its configuration list. In this way, security is increased as prospective product servers or third-party product servers can only query specified parameters. Moreover, the authorization server shall allow the service provider to add, modify and remove allowed product server configurations through a convenient user-interface.

With the above implementations, if a service provider offers access to third party applications, such as Microsoft Bundles, the user may enjoy single sign-on capabilities for all data applications A, B, X, Y offered by the service provider and those data applications offered by a third party. For example, a user accessing third party data applications 400 from a user interface 204 or a mobile station 110 will be prompted to enter a user identifier. In order to authenticate and authorize the user, the third party will query a computer system 406 or authorization server 404 via a LDAP 402 interface. Stored on the computer system 406 or authorization server 404 are user identifiers for each user with service through the service provider Also, by employing an authorization server 404 or computer system 406 for performing the authentication authorization for third parties, single sign-on capabilities may be realized. In this way, user identifier may be populated for all data applications A, B, X, Y offered by a service provider and also populated in the same or different databases for authenticating and authorizing access to third party applications. Thus, we find that a user accessing any data application A, B, X, Y on the service providers network or offered by a third party, the user need only remember one user identifier for accessing all applications.

As shown by the above discussion, many of the functions relating to management of and populating new, changed, or updated user identifiers and related to leveraging HLR authentication are implemented on computers connected for data communication via the components of various networks. The relevant functions may be performed in servers such as 122, 124, 136, and 134 shown in FIG. 1, server 208 as shown in FIG. 2, computer system as shown in FIG. 3, or servers 404 and 406 as shown in FIGS. 4A and 4B. These functions may also be performed by product servers APS, BPS, XPS, and YPS. The hardware of such computer platforms typically is general purpose in nature, albeit with an appropriate network connection for communication via an intranet, the internet and/or other data networks that may connect into the various networks discussed.

As known in the data processing and communications arts, each such general-purpose computer typically comprises a central processor, an internal communication bus, various types of memory (RAM, ROM, EEPROM, cache memory, etc.), disk drives or other code and data storage systems, and one or more network interface cards or ports for communication purposes. The computer system also may be coupled to a display and one or more user input devices (not shown) such as alphanumeric and other keys of a keyboard, a mouse, a trackball, etc. The display and user input element(s) together form a service-related user interface, for interactive control of the operation of the computer system. These user interface elements may be locally coupled to the computer system, for example in a workstation configuration, or the user interface elements may be remote from the computer and communicate therewith via a network. The elements of such a general-purpose computer system also may be combined with or built into routing elements or nodes of the network, such as the IWF or the MSC.

The software functionalities involve programming, including executable code as well as associated stored data. The software code is executable by the general-purpose computer that functions as the particular server, explained above. In operation, the code and possibly the associated data records are stored within the general-purpose computer platform. At other times, however, the software may be stored at other locations and/or transported for loading into the appropriate general-purpose computer system. Hence, the embodiments involve one or more software products in the form of one or more modules of code carried by at least one machine-readable. Execution of such code by a processor of the computer platform enables the platform to implement the catalog and/or software downloading functions, in essentially the manner performed in the embodiments discussed and illustrated herein.

As used herein, terms such as computer or machine “readable medium” refer to any medium that participates in providing instructions to a processor for execution. Such a medium may take many forms, including but not limited to, non-volatile media, volatile media, and transmission media. Non-volatile media include, for example, optical or magnetic disks, such as any of the storage devices in any computer(s) operating as one of the server platform, discussed above. Volatile media include dynamic memory, such as main memory of such a computer platform. Physical transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include, for example: a floppy disk, a flexible disk, hard disk, magnetic tape, any other magnetic medium, a CD-ROM, DVD, any other optical medium, punch cards, paper tape, any other physical medium with patterns of holes, a RAM, a PROM, and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

While the foregoing has described what are considered to be the best mode and/or other preferred embodiments, it is understood that various modifications may be made therein and that the invention or inventions may be implemented in various forms and embodiments, and that they may be applied in numerous applications, only some of which have been described herein. It is intended by the following claims to claim any and all modifications and variations that fall within the true scope of the inventive concepts.

1. A communication network for managing a user identifier of a user accessing data applications, the communication network comprising:
a wireless communication network for linking a mobile station with a data application associated with the wireless network, a user accessing the data application from the mobile station and being identified by mobile station identifiers;
a computer system in communication with the data applications of the wireless communication network, the computer system facilitating user sign-on capabilities to the data applications from the mobile station by leveraging authentication already performed by the Home Location Register (HLR) corresponding to the mobile station identifiers.

2. The communication network according to claim 1, further comprising a communication network other than a wireless communication network for linking a user interface other than a mobile station with a data application associated with the other communication network, the user accessing the data application from the user interface being identified by the user identifier entered by the user.

3. The communication network according to claim 2, further comprising:
a server associated with the wireless communication network for hosting the data application; and
another server associated with the other communication network for hosting the other data application.

4. The communication network according to claim 3, further comprising:
a database in communication with the server associated with the wireless communication network; and
another database in communication with the server associated with the other communication network.

5. The communication network according to claim 4, wherein the computer system facilitates population of the user identifier for the user in the database and in the other database.

6. The communication network according to claim 2, wherein the computer system is configured to store the user identifier.

7. The communication network according to claim 6, wherein the computer system is configured to verify an identity of a received user identifier with the stored user identifier.

8. The communication network according to claim 7, wherein the computer system is configured to verify the identity of the user accessing at least one data application of a plurality of data applications and is configured to store the user identifier with other data applications of the plurality of data applications.

9. The communication network according to claim 2, wherein the computer system is configured for receiving any one of a new, changed, and updated user identifier from the data application associated with the other communication network, for populating the received user identifier with other data applications in the communication network.

10. The communication network according to claim 2, wherein the computer system is configured for receiving any one of a new, changed, and updated user identifier from the data application associated with the wireless communication network, for populating the received user identifier with other data applications in the communication network.

11. The communication network according to claim 1, wherein the computer system employs an Authentication, Authorization, and Accounting (AAA) program at least for authenticating an identity of, and authorizing access for, the user accessing the data application.

12. The communication network according to claim 2, wherein the computer system comprises:
a server employing an Authentication, Authorization, and Accounting (AAA) program for authenticating a user when accessing a data application from the mobile station through one or more elements of the wireless communication network; and
another server in communication with the AAA server for authenticating the user when accessing a data application from the other communication network and authorizing access thereto.

13. The communication network according to claim 2, wherein the computer system is in communication a with third-party network hosting a third-party data application.

14. The communication network according to claim 13, further comprising an interface for interfacing the third-party network with the computer system.

15. The communication network according to claim 14, wherein the interface is a Lightweight Directory Access Protocol (LDAP) interface.

16. The communication network according to claim 14, further comprising an authorization server connected between the interface and the computer system.

17. The communication network according to claim 16, wherein the authorization server is configured for storing a user identifier received from the computer system.

18. The communication network according to claim 17, wherein the authorization server is configured to authenticate and authorize user access to the third party data application, a request for user access being received via the interface.

19. The communication network according to claim 17, wherein the authorization server is configured to authorize user access to a data application of any one of the third party, the wireless communication network, and the other communication network.

20. The communication network according to claim 14, wherein the computer system is configured to authenticate and authorize access to the third party data application and a data application of either the wireless or the other communication network.

21. The communication network according to claim 2, wherein the data application associated with the wireless network and the data application associated with the other communication network are through the same service provider.

23. The communication network according to claim 1, wherein the HLR authenticates a mobile station accessing the wireless network corresponding to mobile station identifiers.

24. The communication network according to claim 23, wherein the computer system is configured to query the HLR for an authenticated mobile station accessing the wireless communication network.

25. The communication network according to claim 24, wherein the computer system queries the HLR for the authenticated mobile station in response to mobile station identifiers received from the data application the user is accessing.

26. The communication network according to claim 25, wherein the computer system is configured to verify the identity of the user accessing the data application based on the authenticated mobile station leveraged from the HLR corresponding to the mobile station identifiers received from the data application.

27. A method for managing authentication of a user accessing data applications of a service provider via at least two different networks, the method comprising the steps of:
receiving a user identifier entered by a user for accessing a data application associated with a wireless communication network;
receiving the user identifier entered by the user for accessing a data application associated with a communication network other than the wireless communication network
accessing a computer system from either the wireless communication network or the other communication network; and
verifying that the entered user identifier matches a stored user identifier in the computer system.

28. The method for managing an identity of a user according to claim 27, further comprising the steps of:
receiving a new, updated, or changed user identifier from the user; and
populating the new, updated, or changed user identifier with data applications accessible through the service provider for facilitating single sign-on.

29. The method for managing an identity of a user according to claim 28, wherein the step of populating the new, updated, or changed user identifier further comprises the step of:
storing the new, updated, or new user identifier in the computer system accessible from the wireless communication network and the other communication network.

30. The method for managing an identity of a user according to claim 28, wherein the step of populating the new, updated, or changed user identifier further comprises the step of:
storing the new, updated, or changed user identifier on a database corresponding to each data application associated with the wireless communication network and each data application associated with the other communication network.

31. The method for managing an identity of a user according to claim 27, further comprising the steps of:
accessing a third party network through the service provider;
receiving the user identifier entered by the user for accessing a data application on the third party network; and
accessing a server or database in communication with the third party network via an interface.

32. The method for managing an identity of a user according to claim 31, wherein the server or database is the computer system.

33. The method for managing an identity of a user according to claim 31, wherein the server or database is in communication with the computer system.

34. The method for managing an identity of a user according to claim 31, further comprising the steps of:
receiving a new, updated, or changed user identifier from a user using the data application on the third party network; and
storing the new, updated, or new user identifier in the server or database.

35. The method for managing an identity of a user according to claim 34, further comprising the step of storing the new, updated, or changed user identifier on a database corresponding to each data application hosted by the wireless communication network and each data application hosted by the other communication network

36. The method for managing an identity of a user according to claim 35, further comprising the step of storing the new, updated, or new user identifier in the computer system accessible from the wireless communication network and the other communication network.

37. The method for managing an identity of a user according to claim 34, further comprising the steps of:
receiving a new, updated, or changed user identifier from a user using the data application on the wireless communication network or the data application on the other communication network; and
storing the new, updated, or new user identifier in the server or database.

38. A method for managing authentication of a user accessing data applications on a wireless communication network, the method comprising the steps of:
receiving a mobile station identifier from a data application associated with a wireless communication network;
comparing the mobile station identifier with a mobile station identifier already authenticated by a Home Location Register; and
verifying that the mobile station corresponding to the mobile station identifier is authorized to access the data application.

39. The method according to claim 38, further comprising:
requesting and receiving authentication information corresponding to the mobile station identifier; and
determining whether the mobile station is authorized to access the data application based on received the mobile station identifier.

40. A program product, comprising executable code transportable by at least one machine readable medium, wherein execution of the code by at least one programmable computer causes the at least one programmable computer to perform a sequence of steps, comprising:
comparing a user identifier received from a data application associated with a wireless communication network with a stored user identifier;
comparing the user identifier received a data application associated with a communication network other than the wireless communication network; and
verifying that the user identifier matches the stored user identifier.

41. The program product according to claim 40, further comprising the steps of:
populating a received new, updated, or changed user identifier with data applications accessible through a service provider for facilitating single sign-on.

42. The program product according to claim 41, wherein the step of populating the new, updated, or changed user identifier further comprises the step of:
storing the new, updated, or new user identifier in a computer system accessible from the wireless communication network and the other communication network.

43. The program product according to claim 41, wherein the step of populating the new, updated, or changed user identifier further comprises the step of:
storing the new, updated, or changed user identifier on a database corresponding to each data application associated with the wireless communication network and each data application associated with the other communication network.

44. The program product according to claim 40, further comprising the steps of:
verifying that a user identifier received from a third party network matches the stored user identifier for access to a data application associated with the third party network.

45. The program product according to claim 44, further comprising the steps of:
storing a new, updated, or changed user identifier received from the third party network.

46. A program product, comprising executable code transportable by at least one machine readable medium, wherein execution of the code by at least one programmable computer causes the at least one programmable computer to perform a sequence of steps, comprising:
comparing the mobile station identifier received from a data application associated with a wireless communication network with a mobile station identifier already authenticated by a Home Location Register; and
verifying that the mobile station corresponding to the mobile station identifier is authorized to access the data application.
